(19) United States
(12) Patent Application Publication
(10) Pub. No.: US 2016/0153936 A1
(43) Pub. Date: Jun. 2, 2016

(54) Capillary Electrophoresis Device

(71) Applicant: HITACHI HIGH-TECHNOLOGIES CORPORATION, Tokyo (JP)

(72) Inventors: Hitoshi MIYATA, Tokyo (JP); Toshiyuki SAKURAI, Tokyo (JP)

(21) Appl. No.: 14/897,085

(22) PCT Filed: Jun. 11, 2014
(86) PCT No.: PCT/JP2014/065404

§ 371 Date: Dec. 9, 2015

(30) Foreign Application Priority Data
Jul. 8, 2013 (JP) 2013-142228

(51) Int. Cl. G01N 27/447

(52) U.S. Cl. CPC G01N 27/44791

(57) ABSTRACT

The purpose of this invention has to do with being able to eliminate, using a small amount of an electrophoresis medium, air bubbles that get mixed in when loading an electrophoresis-medium container into a capillary electrophoresis device. This invention has to do with being able to simplify a positive-electrode-side channel in a capillary electrophoresis device by electrophoresing using only an electrophoresis medium on the positive-electrode side. This invention makes it possible to eliminate, easily and using a small amount of an electrophoresis medium, air bubbles that had become mixed in each time an electrophoresis-medium container was connected to the device. This invention also makes it easier to manage consumables and reduces the number thereof, making pre-electrophoresis preparation simple, and makes it possible to simplify and reduce the size of the device.

### TECHNICAL FIELD

The present invention relates to a technique for separating and analyzing the nucleic acid, protein, or the like through electrophoresis, and particularly to a capillary electrophoresis device.

### BACKGROUND ART

In recent years, a capillary electrophoresis device having a capillary filled with a phoresis medium such as polymer gel or polymer solution has been widely used.

For example, the capillary electrophoresis device as disclosed in PTL 1 has conventionally been used. This device has features of having the higher heat dissipation property than the flat-type electrophoresis device and being capable of faster electrophoresis because the higher voltage can be applied to the sample. Other features are: the necessary amount of sample is small, filling with the separation medium can be automatically carried out, the sample injection can also be automatically carried out, and the like. Such a device is used in various separation and analysis measurements including the analysis of the nucleic acid and protein.

FIG. 1 illustrates an example of the conventional capillary electrophoresis device. The capillary electrophoresis device includes a capillary 101, a power source 102 that applies high voltage to both ends of the capillary 101, an illumination system, which is not shown, including a laser light source and the like, a light-reception optical system, which is not shown, for detecting fluorescence, a thermostat tank 103 that controls the temperature of the capillary, a phoresis medium filling unit 104 that fills the capillary 101 with the phoresis medium, and a carrier, which is not shown, that carries a container containing the sample.

An anode side of the capillary 101 is bonded to a flow channel of the phoresis medium filling unit 104. The flow channel of the phoresis medium filling unit 104 is branched into two channels. One of the channels is bonded to a phoresis medium container 105 while the other is bonded to a buffer solution container A 106.

In the capillary electrophoresis device, the capillary 101 having an inner diameter of as small as 50 μm needs to be filled with the phoresis medium whose viscosity is several hundred times as high as that of water. In view of this, the phoresis medium filling unit 104 has a mechanism that can apply the pressure of several megapascals to one end of the channel for the phoresis medium. One example of this type of mechanism is a plunger pump 107. In the case of FIG. 1, the plunger pump 107 is driven in a direction perpendicular to the paper surface. The driving of the plunger pump 107 changes the capacity of the channel to produce the pressure necessary for filling with the phoresis medium.

In the analysis of the sample, high voltage is applied between opposite ends of the flow channel connected to the capillary 101 (between the buffer solution container A 106 and a buffer solution container B 109), thereby having a fluorescence-labelled sample such as DNA subjected to the electrophoresis in the phoresis medium of the capillary. Here, the charges used in the electrophoresis are mostly the charges in the buffer solution on the anode side. The sample differs in the phoresis speed depending on the molecular size and is detected in the detection unit 108.

Incidentally, the capillary electrophoresis device needs the exchange of the phoresis medium container 105 or the capillary 101. In the exchange of these components, part of the flow channel is exposed to the air, in which case the air may be mixed into the flow channel.

In the electrophoresis, voltage as high as several to several tens of kilovolts is applied between the opposite ends of the flow channel. Therefore, if there is an air bubble in the channel, the bubble may block the channel electrically. If the channel is electrically blocked, the high voltage difference is caused in the blocked portion, which results in the discharge. Depending on the magnitude of the discharge, the capillary electrophoresis device may be destroyed.

In view of the above, it is necessary to remove the air bubble out of the flow channel before the start of the electrophoresis.

For example, if there is an air bubble in the flow channel of the phoresis medium filling unit 104, the connected flow channel between the phoresis medium filling unit 104 and the capillary 101 is closed and in this state, the phoresis medium is supplied to the buffer solution container A 106 in a manner that the medium returns at the branched path in the unit. Thus, the air bubble is removed from the flow channel section of the phoresis medium filling unit 104.

On the other hand, if there is an air bubble in the flow channel of the capillary 101, the capillary 101 is filled with the phoresis medium whose amount is 1.5 times as large as the capacity of the capillary 101. Here, the inner diameter of the capillary 101 is as small as 50 μm. Thus, the air bubble flows inside the capillary 101 together with the phoresis medium and is discharged from the other end of the capillary 101. In other words, the air bubble can be removed from the inside of the capillary.

PTL 2 discloses the mechanism for removing the air bubble from the flow channel of the phoresis medium filling unit 104 with a small amount of phoresis medium. Specifically, the structure is employed which forms the connected flow channel so that the phoresis medium flows from the bottom to the top in the connected portion between the phoresis medium filling unit 104 and the capillary 101.

### CITATION LIST

### Patent Literatures

PTL 1: Japanese Patent No. 2776208

PTL 2: JP-A-2008-8621

### SUMMARY OF INVENTION

### Technical Problem

In the case of the conventional device, since the phoresis medium filling unit 104 has the long flow channel, a large amount of phoresis medium is consumed in removing the air bubbles from the flow channel.

In view of the above, an object of the present invention is to provide a capillary electrophoresis device with the phoresis medium filling unit 104 having the shorter flow channel so as to consume less phoresis medium in removing the air bubbles.

### Solution to Problem

In order to achieve the object, in the present invention, the electrophoresis is carried out with the charges necessary for the electrophoresis not from the buffer solution but from the phoresis medium, i.e., only with the electrophoresis medium in regard to the capillary anode end.

### Advantageous Effects of Invention

According to the present invention, the flow channel from the capillary connected portion to the container containing the buffer solution in the phoresis medium filling unit 104 can be omitted from the flow channel in the electrophoresis. This can suppress the consumption of the phoresis medium required for removing the air bubble out of the phoresis medium filling unit 104.

Furthermore, the buffer solution container 106 is no longer necessary, so that the number of consumption articles can be reduced, which can simplify the preparation before the analysis and the device. As a result, it becomes easier to operate the electrophoresis device.

### BRIEF DESCRIPTION OF DRAWINGS

FIG. 1 is a diagram illustrating a conventional example of a capillary electrophoresis device.

FIG. 2 is a diagram schematically illustrating an entire structure of an electrophoresis device according to Example 1.

FIG. 3 is an external diagram of a capillary array.

FIG. 4A is an external structure diagram of a phoresis medium container.

FIG. 4B is a sectional diagram of the phoresis medium container.

FIG. 4C is an external exploded structure diagram of the phoresis medium container.

FIG. 4D is a structure diagram of a component (lid) of the phoresis medium container.

FIG. 4E is a structure diagram of a component (middle lid) of the phoresis medium container.

FIG. 4F is a structure diagram of a component (rubber film) of the phoresis medium container.

FIG. 4G is a structure diagram of a component (main body portion) of the phoresis medium container.

FIG. 5 is a diagram illustrating a structure of a resin flow channel block with the high electric insulating property used in Example 1.

FIG. 6 is a diagram illustrating a process step of filling the capillary with the phoresis medium.

FIG. 7A is a diagram illustrating the flow channel in the resin flow channel block with the high electric insulating property according to a modified example.

FIG. 7B is a structure diagram in which a hollow pipe is used as an electrode according to a modified example.

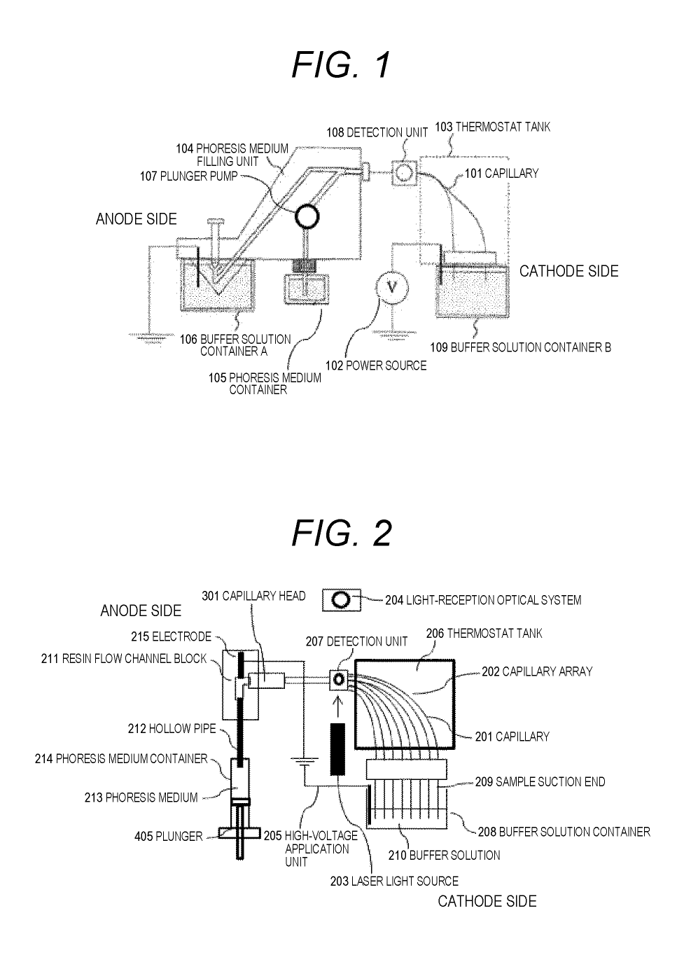

### DESCRIPTION OF EMBODIMENTS

An embodiment of the present invention will be hereinafter described with reference to the drawings. Note that the device structure and the content of the process to be described below correspond to an example of the present invention and will not limit the content of the present invention. Embodiments can be combined with each other, or the embodiment can be combined with a known technique or replaced by a known technique to achieve another embodiment.

A specific example of the device structure of the electrophoresis device suggested by the present inventor is hereinafter described.

### Example 1

### Summary of System

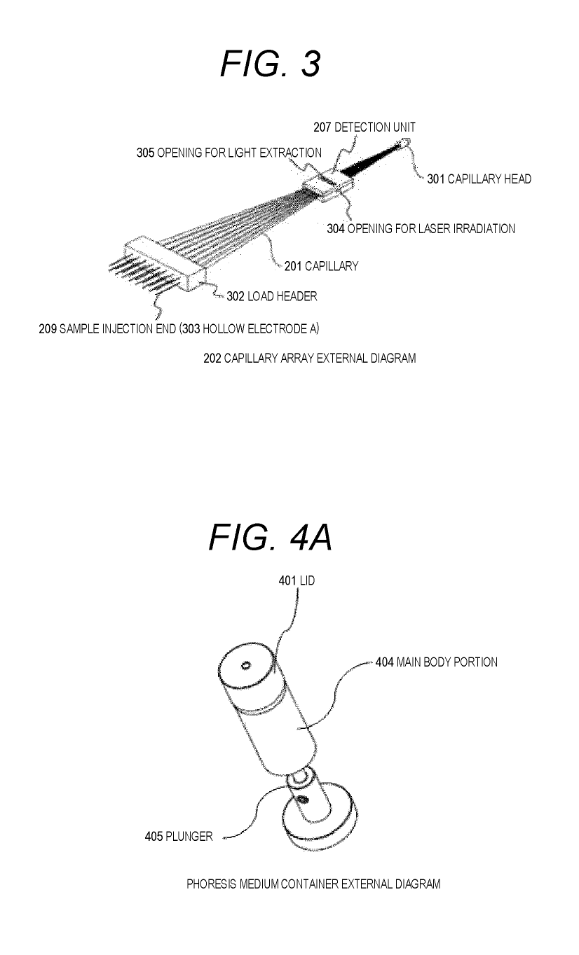

FIG. 2 schematically illustrates the entire structure of an electrophoresis device according to Example 1. The electrophoresis device according to Example 1 includes a capillary array 202, which is a single capillary 201 or a group of capillaries 201, a laser light source 203 that irradiates a fluorescence-labelled sample in the capillary with a laser beam, a light-reception optical system 204 that detects the fluorescence emitted from the sample, a high-voltage application unit 205 that applies high voltage to the capillary, and a thermostat tank 206 that maintains the capillary at a constant temperature.

The capillary array 202 is fixed to the thermostat tank 206. Outside the thermostat tank 206 is provided a detection unit 207 that is used for testing the sample. In the drawing, the side provided with a buffer solution container 208 corresponds to the cathode end of the capillary array 202 and also to a sample suction end 209 through which the sample is injected.

The sample suction end 209 is immersed in a buffer solution 210 in the buffer solution container 208 while the other (capillary head 302) is connected to a resin flow channel block 211 with the high electric insulating property. The resin flow channel block 211 is bonded to a hollow pipe 212 in addition to being bonded to the capillary array 202. This hollow pipe 212 is connected to a phoresis medium container 214 containing a phoresis medium 213. In the resin flow channel block 211, an electrode 215 is also installed.

### (Structure of Capillary Array)

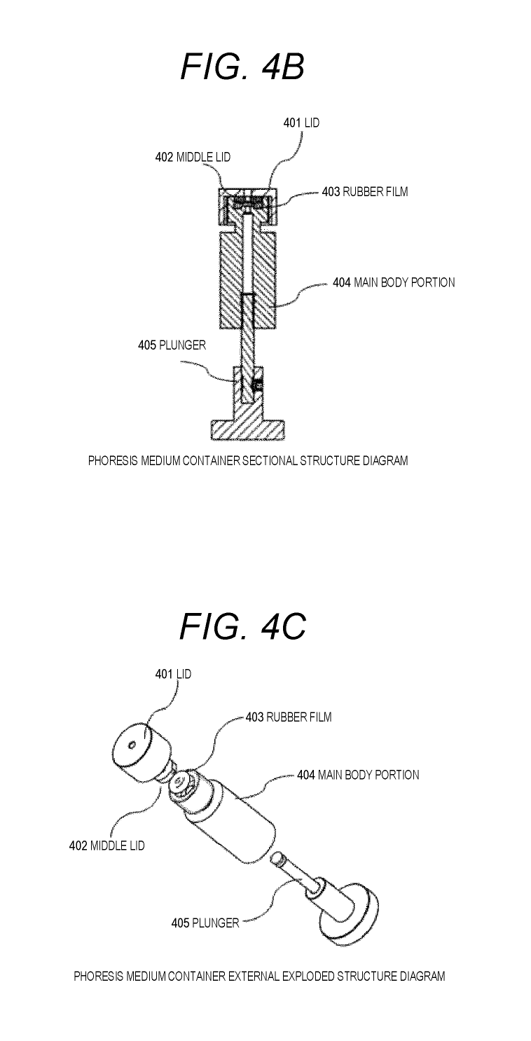

FIG. 3 is an external diagram of the capillary array 202. Description is hereinafter made with reference to FIG. 2 and FIG. 3. Each capillary 201 included in the capillary array 202 has an outer diameter of 0.1 to 0.7 mm and an inner diameter of 0.02 to 0.5 mm, and is coated with polyimide resin on the outside. The capillary 201 itself is a quartz pipe, and one capillary 201 or a plurality of (eight in this example) capillaries 202 is arranged to constitute the capillary array 202. The capillary array 202 includes a load header 302 that takes the sample into the capillary 201 from the sample container containing a fluorescence-labelled DNA sample or the like by the electric operation, the detection unit 207 that arranges and fixes the capillaries 201 in the order of the sample number of the load header 302, and a capillary head 301 binding and bonding the plural capillaries 201. The sample suction end 209 projecting from the load header 302 is provided with a hollow electrode A 303 for applying the high voltage to the capillary 201. The detection unit 301 includes an opening 304 through which the aligned and held capillary array 202 is irradiated with the laser beam from the side, and an opening 305 through which the light emitted from the capillary is extracted.

In regard to the shape of the connected portion between the capillary head 301 of the capillary array 202 and the resin flow channel block 211, a sleeve is attached to the round capillary head 301 binding the capillaries 201, and the sleeve is deformed by fastening a setscrew, thereby filling the space. This enables the capillary head 301 to be fixed to the resin flow channel block 211.

### (Structure of Phoresis Medium Container)

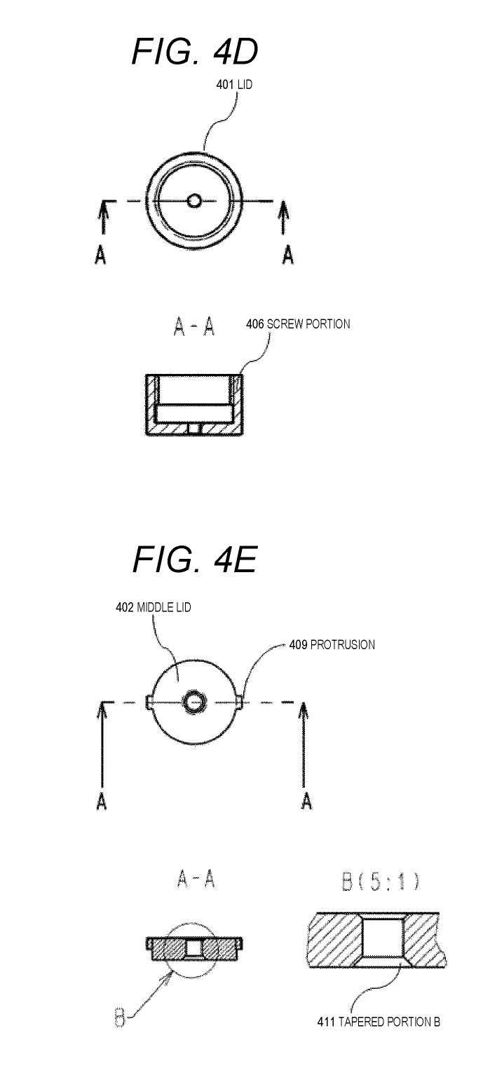

FIGS. 4(A) to 4(G) illustrate the detailed structure of the phoresis medium container 214 used in the examples. FIG. 4(A) is an external structure diagram of the phoresis medium container 214, FIG. 4(B) is a sectional structure diagram, FIG. 4(C) is an external exploded structure diagram, and FIG. 4(D) to FIG. 4(G) are external structure diagrams of the components.

The phoresis medium container 214 includes a lid 401, a middle lid 402, a rubber film 403, a main body portion 404, and a plunger 405. The rubber film 403 is fixed to the main body portion 404 with the middle lid 402 interposed therebetween when the lid 401 is rotated by a screw portion 406 provided for the lid 401. On this occasion, the middle lid 402 is set so that a tapered portion A 407 of the rubber film 403 is not twisted by the rotation of the lid 401. In this structure, as illustrated in FIG. 00, a protrusion 409 of the middle lid 402 is fitted to a groove 408 of the main body portion 404, and when the lid 401 is fastened, the middle lid 402 transmits only the force in the vertical direction to the rubber film 403. Further, the hollow pipe 212 is penetrated through a depressed portion 410 above the rubber film 403. When the phoresis medium 214 is supplied by the plunger 405, the tapered portion A 407 of the rubber film 403 is pressed by a tapered portion B 411 of the middle lid 402, whereby the leakage from around the hollow pipe 212 is prevented during the penetration of the hollow pipe 212.

### (Structure of Resin Flow Channel Block 211)

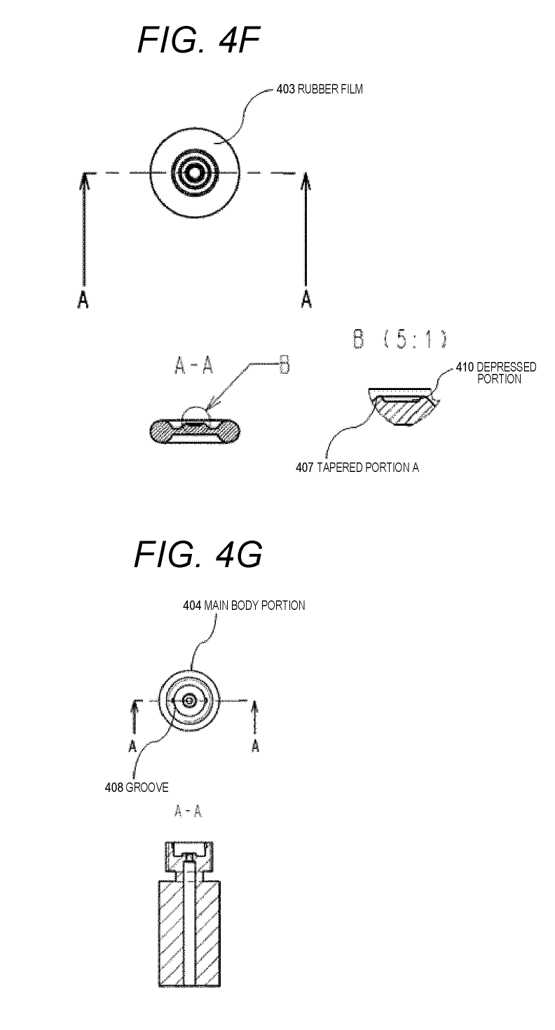

FIG. 5 illustrates the structure of the resin flow channel block 211 used in Example 1. The resin flow channel block 211 includes the hollow pipe 212 and the electrode 215.

Moreover, the flow channel in the resin flow channel block 211 has the smaller diameter than the air bubble generated in the flow channel so that when the capillary 201 is filled with the phoresis medium 213, the air bubble in the flow channel in the resin flow channel block 211 can move for sure. In this example, the flow channel has an inner diameter of φ0.5 mm.

### (Operation of Entire Device)

Next, description is made of a series of process operations of the capillary electrophoresis device according to this example. The operation including the application of voltage for the electrophoresis in the capillary electrophoresis device to be described below is performed through a control unit (such as a computer), which is not shown.

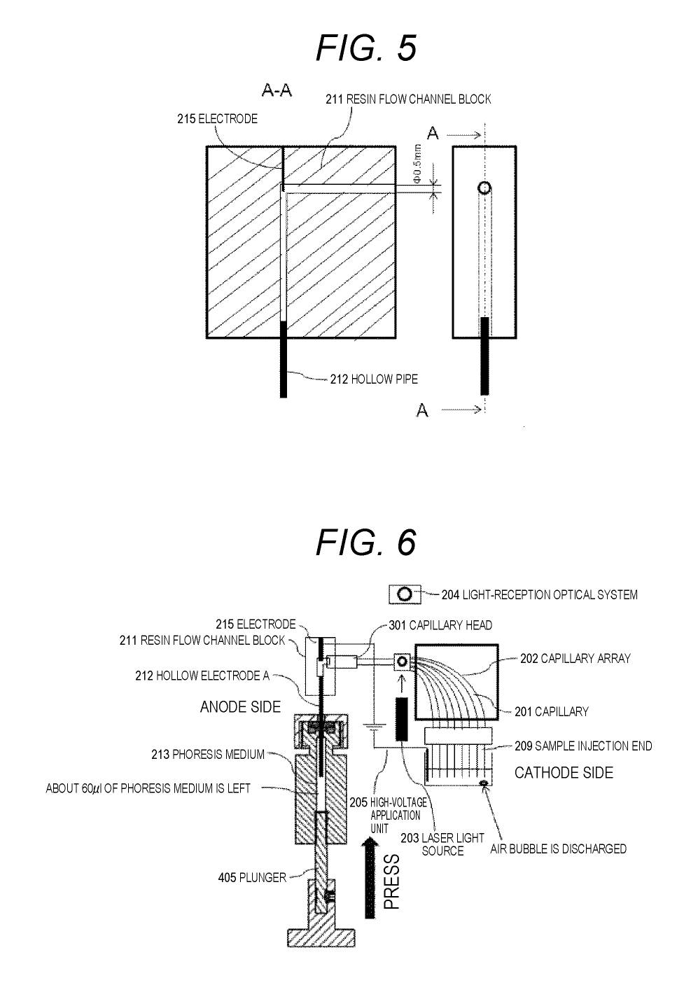

FIG. 6 illustrates a process step of filling the capillary array 202 with the phoresis medium 213.

First, the hollow pipe 212 is penetrated into the phoresis medium container 214. After that, the plunger 405 of the phoresis medium container 214 is pressed to inject the phoresis medium 213 into the capillary 201. On this occasion, the air bubbles mixed into the resin flow channel block 211 and the hollow pipe 212 go through the resin flow channel block 211 and moreover through the capillary 201 together with the phoresis medium 213 because the inner diameter of the capillary 201 is small, and then is discharged out of the sample suction end 209. The amount of phoresis medium 213 injected into the capillary 201 is about 1.5 times as large as the inner capacity of the hollow pipe 212 and the rein flow channel block 211+the inner capacity of the capillary array 202. In the flow channel of the resin flow channel block 211 and the phoresis medium container 214, the phoresis medium 213 with the charges necessary for one electrophoresis is left. In this example, the capillary array 202 has a length of 26 cm, 8 channels, and an inner diameter of φ50 μm. The amount of charges necessary for the electrophoresis is set to 87 mC from the experiments, and this amount is satisfied by approximately 60 μl of phoresis medium (POP-7™) manufactured by Life Technologies. When the phoresis medium 213 is filled, the sample suction end 209 is immersed in a waste tank (filled with pure water), which is not shown, carried by a carrier tray, which is not shown.

After that, the sample suction end 209 is sank into the sample container, which is not shown, carried by the carrier tray, which is not shown, and then sank into the container containing pure water (for cleaning), which is not shown, and into the buffer solution container 208 in this order. After that, the electrophoresis is started in the state that the sample suction end 209 of the capillary array 202 is immersed in the buffer solution container 208.

As described above, the use of the electrophoresis device according to this example can easily remove the air bubbles, which are mixed in the setting of the phoresis medium container 214 and the capillary array 202, with a small amount of phoresis medium 213 and can drastically reduce the running cost. Furthermore, the preparation for the electrophoresis can be facilitated as compared to the conventional device.

### Example 2

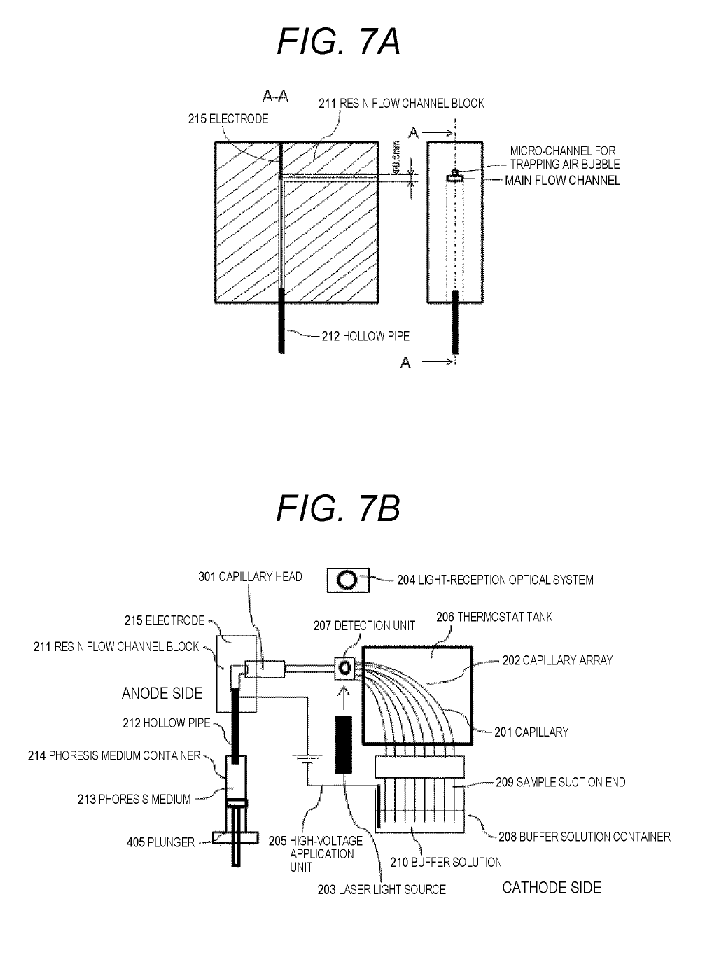

In the description above, the flow channel of the resin flow channel block 211 has the circular shape with the diameter smaller than that of the air bubble generated in the flow channel, so that the air bubble moves certainly and is not left in the flow channel. Even if the air bubble is mixed in the resin flow channel block 211, a problem does not occur as long as the air bubble does not block the flow channel, i.e., the air bubble is not left in the place where the electrophoresis is interrupted. For example, the micro-channel may be provided for trapping the air bubble, which is well known as the flow channel for the micro-chemical chip like the flow channel illustrated in FIG. 7A. In the micro-channel, the air bubble is easily formed on the smaller channel side due to the surface tension. Using this phenomenon, the air bubble mixed in the resin flow channel block 211 is moved toward the micro-channel, so that the wider flow channel can secure the bypass flow. Accordingly, the electrophoresis is not interrupted.

In the above description, the resin flow channel block 211 includes the hollow pipe 212 and the electrode 215. However, the hollow pipe may be used as the electrode and the electrode may be omitted as illustrated in FIG. 7B.

In the above description, the resin flow channel block 211 and the capillary head 301 are structured as separate parts. However, these parts may be an integrated component.

### REFERENCE SIGNS LIST

101 capillary
102 power source
103 thermostat tank
104 phoresis medium filling unit
105 phoresis medium container
106 buffer solution container A
107 plunger pump
108 detection unit
109 buffer solution container B
201 capillary
202 capillary array
203 laser light source
204 light-reception optical system
205 high-voltage application unit
206 thermostat tank
207 detection unit
208 buffer solution container
209 sample suction end
210 buffer solution
211 resin flow channel block
212 hollow pipe
213 phoresis medium
214 phoresis medium container
215 electrode
301 capillary head
302 load header
303 hollow electrode A
304 opening for delivering laser beam
305 opening for extracting emitted light
401 lid
402 middle lid
403 rubber film
404 main body portion
405 plunger
406 screw portion
407 tapered portion A
408 groove
409 protrusion
410 depressed portion
411 tapered portion B

1. A capillary electrophoresis device comprising:
a capillary;
a buffer solution container where a sample suction end corresponding to one end of the capillary through which a sample is injected is immersed in a buffer solution;
a flow channel to which a capillary head corresponding to the other end of the capillary is connected;
a phoresis medium container containing a phoresis medium, which is connected to the flow channel; and
a mechanism for injecting the phoresis medium in the phoresis medium container to the capillary through the flow channel; wherein
the phoresis medium container includes a lid, a middle lid, a rubber film, a main body portion, and a plunger,
the lid is provided with a screw portion for fixing the lid to the main body portion by rotating the lid, and
the main body portion and the middle lid are fixed by being fitted to each other and only a force in a vertical direction is transmitted to the rubber film when the lid is fastened.

2. The capillary electrophoresis device according to claim 1, wherein the flow channel includes a flow channel block to which the capillary head is connected, and a hollow pipe connected to the flow channel block.

3. The capillary electrophoresis device according to claim 1, wherein the mechanism is a plunger connected to the phoresis medium container and is configured to inject the phoresis medium in the phoresis medium container into the capillary by moving the plunger.

4. The capillary electrophoresis device according to claim 1, further comprising:
a laser light source for delivering a laser beam to a fluorescence-labelled sample in the capillary;
a light-reception optical system for detecting fluorescence emitted from the sample; and
a high-voltage application unit for applying high voltage to the capillary.

5. The capillary electrophoresis device according to claim 1, wherein the high-voltage application unit is configured such that an electrode on a cathode side is disposed in the buffer solution container, an electrode on an anode side is disposed in the flow channel, and high voltage is applied to the capillary.

6. The capillary electrophoresis device according to claim 1, wherein a DNA fragment subjected to the electrophoresis toward the anode side is pushed toward the cathode side through the capillary.

7. The capillary electrophoresis device according to claim 1, wherein the phoresis medium used in the electrophoresis is discharged toward the cathode side.

8. The capillary electrophoresis device according to claim 1, wherein an electrophoresis path is secured by a micro-channel even if an air bubble is mixed in a flow channel of a flow channel block.

9. The capillary electrophoresis device according to claim 1, wherein the capillary head and the flow channel block are integrated.

10. The capillary electrophoresis device according to claim 1, wherein the main body portion is provided with a groove and the middle lid is provided with a protrusion to be fitted into the groove.

11. The capillary electrophoresis device according to claim 1, wherein the rubber film and the middle lid are provided with a tapered portion, and the tapered portion of the middle lid is pressed against the tapered portion of the rubber film when the lid is fixed to the main body portion.
